(19) United States
(12) Patent Application Publication
(10) Pub. No.: US 2025/0154071 A1
(43) Pub. Date: May 15, 2025

(54) ENVIRONMENTAL BARRIER MATERIALS AND COATINGS CONTAINING LOW MELTING TEMPERATURE PHASES

(71) Applicant: OERLIKON METCO (US) INC., Westbury, NY (US)

(72) Inventor: Dianying CHEN, Westbury, NY (US)

(73) Assignee: OERLIKON METCO (US) INC., Westbury, NY (US)

(21) Appl. No.: 18/838,809

(22) PCT Filed: Apr. 10, 2023
(86) PCT No.: PCT/US2023/018049

§ 371 Date: Aug. 15, 2024

Related U.S. Application Data
(60) Provisional application No. 63/329,575, filed on Apr. 11, 2022.

(51) Int. Cl. C04B 35/622; C04B 35/16; C04B 41/45; C04B 41/87

(52) U.S. Cl. CPC C04B 35/62222; C04B 35/16; C04B 41/4523; C04B 41/87; C04B 2235/3224; C04B 2235/3427

(57) ABSTRACT

Environmental barrier materials and coatings containing low melting temperature materials are provided. The materials and coatings include high melting temperature materials, such as rare earth silicates, mullite, hafnon, zircon, HfO₂, and rare earth stabilized ZrO₂. The low melting temperature materials have a melting temperature of less than 1500° C. The low melting temperature materials in the coating in-situ melt, flow, and fill the microstructural defects after post-heat treatment. Due to reduced microstructural defects, EBCs containing low melting temperature materials provide an enhanced barrier against oxidants diffusion and result in 10 times slower TGO growth rate as compared to coatings without low melting temperature materials.

### CROSS-REFERENCE TO RELATED APPLICATION

This application claims the benefit under 35 U.S.C. § 119 (e) of U.S. Provisional Application No. 63/329,575 filed Apr. 11, 2022, the disclosure of which is expressly incorporated by reference herein in its entirety.

### BACKGROUND OF THE INVENTION

### 1. Field of the Disclosure

The present disclosure relates to environmental barrier coatings (EBCs) on Si-based ceramic matrix composites (CMCs) that can protect the CMCs in a high temperature oxidation environment. In example embodiments, a thermal spray material feedstock containing low melting temperature materials in-situ melt, diffuse, and fill EBCs microstructural defects during high temperature coating conditions. Due to reduced microstructural defects, EBCs containing low melting temperature materials provide an enhanced barrier against oxidant (water vapor and oxygen) diffusion and result in more than two times slower thermally grown oxide (TGO) growth rate as compared to coatings without low temperature materials. For example, in some preferred embodiments, the TGO growth rate is five times (or more) slower in the EBC coatings containing low melting temperature materials as compared with EBC coatings without low melting temperature materials. In still more preferred embodiments, the TGO growth rate is 10 times (or more) slower in the EBC coatings containing low melting temperature materials as compared with EBC coatings without low melting temperature materials.

### 2. Background Information

Rare earth silicates and mullite have been conventionally used for environmental barrier coatings (EBCs) that are applied onto Si-based ceramic matrix composites to protect the CMCs from oxidation and water vapor attack. Conventional EBCs contain a Si-bond coat and a ytterbium silicate top coat. Air plasma spray (APS) is a conventionally used process for EBC deposition. However, the coating after the APS process typically contains at least some degree of porosity and microstructural defects, such as splat boundaries and micro-cracks. In a high temperature gas turbine engine environment, these microstructural defects provide a fast diffusion path for oxidants (water vapor and oxygen) to reach the Si-bond coat and accelerate Si-bond coat oxidation. When exposed to a high temperature oxidation environment in gas turbine engines, the Si-bond coat will also be oxidized to form a thermally grown oxide (TGO) SiO₂ layer. EBCs will spall when the TGO layer reaches a threshold thickness. Thus, new dense and crack-free EBCs to protect the Si-bond coat and CMCs substrate from oxidation, reduce the TGO growth rate, and improve the coating durability are needed.

### SUMMARY

The aim of the present disclosure is to obtain dense and crack free EBCs, which can prevent oxidant (water vapor and oxygen) from reaching the lower layer components (e.g., the silicon bond coat and/or CMC substrate). In some embodiments, such EBCs may be obtained from a thermal spray material feedstock that includes a first powder comprising at least one low melting temperature material having a melting temperature of less than 1500° C., and a second powder comprising at least one environmental barrier coating matrix material (which is generally a high melting temperature matrix material).

In some embodiments, the at least one low melting temperature material is a single oxide compound, a binary oxide, a ternary oxide, or multiple oxides. For example, in some embodiments, the low melting temperature material may comprise at least four oxides having a melting temperature of less than 1300° C.

In some embodiments, the at least one environmental barrier coating matrix material (which is generally a high melting temperature matrix material) comprises at least one material selected from the group consisting of a rare earth silicate, a rare earth oxide, mullite, alkaline silicate, HfO₂, HfSiO₄, HfTiO₄, ZrTiO₄, ZrSiO₄, a rare earth oxide stabilized zirconia, a rare earth oxide stabilized hafnia, HfB₂, HfC, ZrB₂, ZrC, and SiC.

In some embodiments, the first powder and the second powder are blended, agglomerated, agglomerated and sintered, plasma densified, or fused and crushed.

In some specific embodiments, the at least one low melting temperature material comprises CaO, MgO, Al₂O₃, SiO₂, Na₂O, K₂O and Fe₂O₃. In other embodiments, at least one low melting temperature material is Li₂O.

In some embodiments, the EBC may include an EBC top coat that comprises an EBC matrix (which is generally a high melting temperature matrix material) comprising a material selected from the group consisting of a rare earth silicate, a rare earth oxide, mullite, alkaline silicate, HfO₂, HfSiO₄, HfTiO₄, ZrTiO₄, ZrSiO₄, a rare earth oxide stabilized zirconia, a rare earth oxide stabilized hafnia HfB₂, HfC, ZrB₂, ZrC, SiC, and combinations thereof, and at least one low melting temperature material having a melting temperature of less than 1500° C. that is embedded in the EBC matrix; and a Si-based bond coat.

In some embodiments, the at least one low melting temperature material of the EBC may comprise CaO, MgO, Al₂O₃, SiO₂, Na₂O, K₂O and Fe₂O₃. In other embodiments, the at least one low melting temperature material of the EBC is Li₂O.

In some embodiments, the EBC matrix comprises at least one rare earth silicate comprising at least one rare earth element selected from the group consisting of Y, La, Ce, Pr, Nd, Pm, Sm, Eu, Gd, Tb, Dy, Ho, Er, Tm, Yb, Lu. In other embodiments, the EBC matrix comprises at least one rare earth oxide comprising at least one rare earth element selected from the group consisting of Y, La, Ce, Pr, Nd, Pm, Sm, Eu, Gd, Tb, Dy, Ho, Er, Tm, Yb, and Lu.

### BRIEF DESCRIPTION OF THE DRAWINGS

The present disclosure is further described in the detailed description which follows, in reference to the noted plurality of drawings, by way of non-limiting examples of preferred embodiments of the present disclosure.

FIG. 1 is a schematic drawing of an as-deposited coating microstructure.

FIG. 2A is a schematic drawing of a blended powder including a matrix powder and a low melting temperature powder.

FIG. 2B is a schematic drawing of an agglomerated powder including a matrix powder and a low melting temperature powder.

FIG. 3 illustrates a scanning electron microscope (SEM) image of a high melting temperature matrix powder and a first low melting temperature powder.

FIG. 4A is an illustration of a SEM image of an as-sprayed APS Yb₂Si₂O₇ coating showing the micro-cracks and splat boundaries.

FIG. 4B is an illustration of a SEM image of a heat-treated APS Yb₂Si₂O₇ coating showing the micro-cracks and splat boundaries.

FIG. 4C is an illustration of a SEM image of as-sprayed APS Yb₂Si₂O₇-sodium calcium magnesium aluminosilicate coating.

FIG. 4D is an illustration of a SEM image of a heat-treated APS Yb₂Si₂O₇-sodium calcium magnesium aluminosilicate coating.

FIG. 5A is an illustration of a SEM image of a Yb₂Si₂O₇ coating evaluated at 1316° C. in 90 vol % H₂O-10 vol % air after 170 hours exposure time.

FIG. 5B is an illustration of a SEM image of a Yb₂Si₂O₇ coating evaluated at 1316° C. in 90 vol % H₂O-10 vol % air after 510 hours exposure time.

FIG. 5C is an illustration of a SEM image of a Yb₂Si₂O₇-sodium calcium magnesium aluminosilicate coating evaluated at 1316° C. in 90 vol % H₂O-10 vol % air after 170 hours exposure time.

FIG. 5D is an illustration of a SEM image of a Yb₂Si₂O₇-sodium calcium magnesium aluminosilicate coating evaluated at 1316° C. in 90 vol % H₂O-10 vol % air after 510 hours exposure time.

FIG. 6 is a graph showing the TGO thickness as a function of exposure for a Yb₂Si₂O₇ coating and an APS Yb₂Si₂O₇-sodium calcium magnesium aluminosilicate coating.

FIG. 7 is an illustration of a SEM image of a high melting temperature matrix powder and a second low melting temperature powder.

FIG. 8A is an illustration of a SEM image of an as-sprayed APS Yb₂Si₂O₇-0.4 wt % Li₂O coating.

FIG. 8B is an illustration of a SEM image of a heat-treated APS Yb₂Si₂O₇-0.4 wt % Li₂O coating.

FIG. 9A is an illustration of a SEM image of a Yb₂Si₂O₇ coating evaluated at 1316° C. in 90 vol % H₂O-10 vol % air after 410 hours exposure time.

FIG. 9B is an illustration of a SEM image of a Yb₂Si₂O₇-0.4 wt % Li₂O coating evaluated at 1316° C. in 90 vol % H₂O-10 vol % air after 410 hours exposure time.

### DETAILED DESCRIPTION

In the following description, the various embodiments of the present disclosure will be described with respect to the enclosed drawings. As required, detailed embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

As used herein, the singular forms “a,” “an,” and “the” include the plural reference unless the context clearly dictates otherwise. For example, reference to “a powder material” would also mean that mixtures of one or more powder materials can be present unless specifically excluded. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 40, it is deemed to include, for example, 1, 7, 23.7, 34, 36.1, 40, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within +5% of the value. As one example, the phrase “about 100” denotes a range of 100±5, i.e., the range from 95 to 105. Generally, when the terms “about” and “approximately” are used, it can be expected that similar results or effects according to the disclosure can be obtained within a range of +5% of the indicated value.

The term “at least partially” is intended to denote that the following property is fulfilled to a certain extent (such as 25% or 50%) or completely.

The terms “substantially” and “essentially” are used to denote that the following feature, property or parameter is either completely (entirely) realized or satisfied or to a major degree (such as 90%, 95%, or 99%) that does not adversely affect the intended result.

The term “comprising” as used herein is intended to be non-exclusive and open-ended. Thus, for example a composition comprising oxide A may include other oxides besides A. However, the term “comprising” also covers the more restrictive meanings of “consisting essentially of” and “consisting of”, so that for example “a composition comprising oxide A” may also (essentially) consist of the oxide A.

In the present disclosure, unless otherwise noted, all weight percentages pertaining to an element/component of a composition/material/layer are based on the total weight of the composition/material/layer including any unavoidable impurities that may be present.

The present disclosure relates to an EBC (such as, for example, an EBC that includes an EBC top coat and a Si-based bond coat), and methods in which the EBC is applied to a substrate (and the articles formed from applying the EBC to a substrate), such as a substrate selected from Si-based ceramic matrix composites (CMCs). In embodiments, the EBC coating compositions and structural arrangements of the EBCs of present disclosure can achieve exceptional environmental barrier coating bond coat adhesion, oxidation and fatigue resistance, and environmental protection performance, along with self-healing capabilities that can ensure long-term durability for CMCs.

In embodiments, the EBC of the present disclosure comprises a matrix (i.e., an environmental barrier coating matrix) that includes a high melting temperature matrix material selected from the group consisting of rare earth silicates (including one or more rare earth element selected from Y, La, Ce, Pr, Nd, Pm, Sm, Eu, Gd, Tb, Dy, Ho, Er, Tm, Yb, and Lu), rare earth oxides (including one or more rare earth element selected from Y, La, Ce, Pr, Nd, Pm, Sm, Eu, Gd, Tb, Dy, Ho, Er, Tm, Yb, and Lu), mullite (3Al₂O₃-2SiO₂), alkaline silicate, HfO₂, HfSiO₄, HfTiO₄, ZrTiO₄, ZrSiO₄, a rare earth oxide stabilized zirconia, a rare earth oxide stabilized hafnia, HfB₂, HfC, ZrB₂, ZrC, SiC, and combinations thereof; and at least one low melting temperature material having a melting temperature of less than 1500° C. that is embedded in the environmental barrier coating matrix (high melting temperature matrix material).

In some embodiments, the at least one low melting temperature material having a melting temperature of less than 1500° C. may be embedded in the environmental barrier coating matrix (high melting temperature matrix material) at an amount that is in the range of from 0.1 wt % to 10 wt % (with respect to the total combined weight of the at least one low melting temperature material and the environmental barrier coating matrix (high melting temperature matrix material)), preferably at an amount that is in the range of from 0.1 wt % to 5 wt %, or more particularly at an amount that is in the range of from 0.3 wt % to 4 wt %.

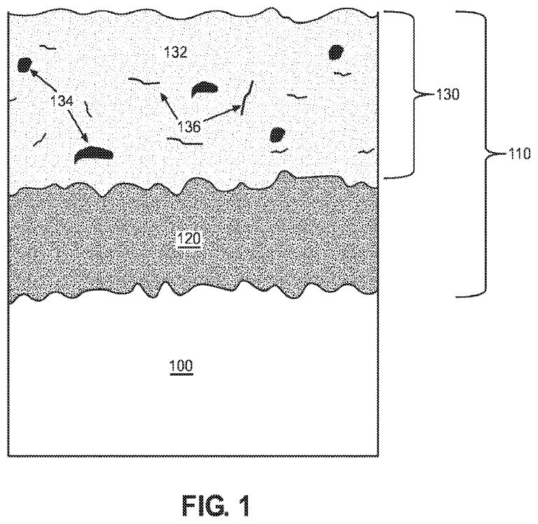

As shown in FIG. 1, in some embodiments, the EBC 110 is composed of multiple layers that are directly adjacent to the substrate 100 (e.g., a SiC/SiC ceramic matrix composite substrate, etc.), which can provide enhanced environmental protection. In such embodiments, the EBC 110 can include a Si-based bond coat 120 and an EBC top coat 130.

When present, the Si-based bond coat 120 may have any desired coating thickness or range of coating thicknesses, e.g., such as a coating thickness that is a range of from 5 μm to 200 μm. In embodiments, the Si-based bond coat may comprise a Si-based metal. In some embodiments, the Si-based bond coat may be made of one or more of the following: MoSi₂ or HfSi₂, or Si—Al₂O₃, Si—Al₂O₃-RE₂O₃ (where RE is a rare earth element).

The EBC top coat 130 can have any desired coating thickness or range of coating thicknesses, e.g., such as a coating thickness that is a range of from 50 μm to 1000 μm. In embodiments, the EBC topcoat layer 130 may include a high melting temperature matrix material 132 and a low melting temperature material 134 embedded within the high melting temperature matrix material 132. FIG. 1 also schematically shows micro-cracks 136 that may occur throughout a EBC topcoat layer 130.

In some embodiments, the low melting temperature material is at least one oxide compound (i.e., where respective powder particle or phase is made of a single oxide compound) shown in Table 1 (below).

TABLE 1

| | Melting |
|---|---|
| Materials | Temperature (° C.) |
| P₂O₅ | 340 |
| K₂O | 350 |
| B₂O₃ | 510 |
| KF | 858 |
| BaB₈O₁₃ | 890 |
| Co₂O₃ | 895 |
| Co₃O₄ | 900 |
| Ba₂B₁₀O₁₇ | 905 |
| BaB₄O₇ | 910 |
| Li₂B₄O₇ | 917 |
| Zn₃B₂O₆ | 980 |
| Fe₂B₂O₅ | 980 |
| CaB₄O₇ | 986 |
| MgB₂O₄ | 988 |
| LiNiO₂ | 1000 |
| Ba₂B₂O₅ | 1050 |
| Na₂SiO₃ | 1088 |
| BaB₂O₄ | 1095 |
| LiCoO₂ | 1100 |
| BaB₂O₄ | 1100 |
| Fe₃BO₅ | 1100 |
| NaAlSi₃O₈ | 1100 |
| GeO₂ | 1115 |
| Nd(BO₂)₃ | 1120 |
| Na₂O | 1132 |
| Fe₂SiO₄ | 1200 |
| Nd₄B₂O₉ | 1200 |
| MgB₂O₄ | 1200 |
| Li₃PO₄ | 1205 |
| Li₄SiO₄ | 1258 |
| MgF₂ | 1263 |
| Mg₂B₂O₅ | 1310 |
| CuO | 1326 |
| Mg₃B₂O₆ | 1340 |
| BaTi₂O₅ | 1375 |
| FeO | 1377 |
| Ba₃B₂O₆ | 1383 |
| CaAl₂O₄ | 1390 |
| CaF₂ | 1418 |
| Ba₄Ti₁₃O₃₀ | 1430 |
| Li₂O | 1438 |

In another embodiment, the low melting temperature material is at least one binary oxide shown in Table 2 (below).

TABLE 2

| | Melting |
|---|---|
| Materials | Temperature (° C.) |
| NaAlSiO₄-x SiO₂ (X = 0.4-0.9 mol) | 1080-1400 |
| Li₂SiO₃-x CaSiO₃ (X = 0.0-0.9 mol) | 1074-1450 |
| Li₂SiO₃-x MgO (X = 0.0-0.5 mol) | 1074-1500 |
| Li₂O-xCaO (x = 0-0.4 mol) | 1438-1500 |
| Li₂O-xMgO (x = 0-0.15 mol) | 1438-1500 |
| Li₂O-xCaAl₂O₄ (x = 0.0-0.7) | 1438-1500 |
| Li₄SiO₄-xMg₂SiO₄ (x = 0.01-0.8 mol) | 1258-1500 |
| Na₂O-xSiO₂ (X = 0.0-0.9 mol) | 850-1500 |
| Li₂O-xTiO₂ (x = 0.0-0.9 mol) | 1050-1500 |
| CaSiO₃-xNa₂SiO₃ (x = 0.05-1.0) | 1088-1500 |
| Al₂O₃-xB₂O₃ (x = 0.85-0.95) | 1000-1500 |
| BaO-xB₂O₃ (x = 0.2-0.95 mol) | 850-1500 |
| Nd₂O₃-xB₂O₃ (x = 0.2-0.95 mol) | 900-1500 |
| MgO-xB₂O₃ (x = 0.1-0.95 mol) | 900-1500 |
| FeO-xB₂O₃ (x = 0.0-0.95 mol) | 900-1500 |
| MgO-xB₂O₃ (x = 0.1-0.95 mol) | 970-1500 |
| BaO-xTiO₂ (x = 0.6-0.8 mol | 1320-1500 |

In yet another embodiment, the low melting temperature material is at least one ternary oxide shown in Table 3 (below).

TABLE 3

| | Melting |
|---|---|
| Ternary Materials | Temperature (° C.) |
| (0.2-0.5 mol)MgO-(0.1-0.3 mol) Al₂O₃- | 1200-1500 |
| (0.2-0.5 mol)B₂O₃ | |
| (0.2-0.5 mol)CaO-(0.05-0.5 mol) Al₂O₃- | 1170-1500 |
| (0.4-0.8 mol)SiO₂ | |
| (0.2-0.5 mol)CaO-(0.2-0.5 mol) MgO- | 1300-1500 |
| (0.4-0.7 mol)SiO₂ | |
| (0.1-0.4 mol)MgO-(0.2-0.4 mol)Al₂O₃- | 1300-1500 |
| (0.5-0.7 mol)SiO₂ | |
| (0.05-0.2 mol)Na₂O-(0.05-0.2 mol) Al₂O₃- | 1000-1400 |
| (0.6-0.8 molSiO₂ | |
| (0.1-0.6 mol))BaO-(0.05-0.3 mol)B₂O₃- | 850-1400 |
| (0.3-0.8 mol)SiO₂ | |
| (0.1-0.7 mol)B₂O₃-(0.05-0.25 mol)Al₂O₃- | 1200-1500 |
| (0.1-0.8 mol)SiO₂ | |
| (0.05-0.9 mol)Li₂O-(0.05-0.9 mol)B₂O₃- | 900-1500 |
| (0.05-0.9 mol)Y₂O₃ | |

In still another embodiment, the low melting temperature material is at least one multiple oxide mixture shown in Table 4 (below).

TABLE 4

| | Melting |
|---|---|
| Multiple oxides materials | Temperature (C.) |
| Na₂O-CaO-Al₂O₃-SiO₂ | 900-1300 |
| CaO-MgO-FeO-SiO₂ | 900-1300 |
| CaO-Al₂O₃-FeO-SiO₂ | 900-1300 |
| B₂O₃-Al₂O₃-BaO-SiO₂ | 900-1300 |
| B₂O₃-Al₂O₃-Na₂O-SiO₂ | 900-1300 |
| CaO-MgO-Al₂O₃-SiO₂ | 900-1300 |
| Na₂O-Al₂O₃-K₂O-SiO₂ | 900-1300 |
| P₂O₅-CaO-TiO₂-Na₂O | 900-1300 |
| P₂O₅-Li₂O-Al₂O₃-TiO₂ | 900-1300 |
| CaO-MgO-Al₂O₃-FeO-SiO₂ | 900-1300 |
| SiO₂-Al₂O₃-Fe₂O₃-CaO-Na₂O-K₂O | 900-1300 |
| SiO₂-Al₂O₃-CaO-MgO-Na₂O-K₂O | 900-1300 |
| SiO₂-Al₂O₃-Fe₂O₃-CaO-MgO-Na₂O-K₂O | 900-1300 |
| CaO-MgO-Al₂O₃-SiO₂-Na₂O-K₂O-Fe₂O₃ | 900-1300 |
| SiO₂-Al₂O₃-CaO-Fe₂O₃-MgO-Na₂O-K₂O-TiO₂ | 900-1300 |
| P₂O₅-Na₂O-Al₂O₃-Fe₂O₃-Cr₂O₃-SrO | 900-1300 |

In some embodiments, the low melting temperature material may be formed from a calcium-magnesium-alumina-silicate (CMAS) powder (having a melting temperature of less than 1500° C.), such as a CMAS powder comprising: 29 wt % to 39 wt % quartz (SiO₂), 25 wt % to 35 wt % gypsum (CaSO₄×2H₂O), 12 wt % to 23 wt % aplite (SiO₂+KAlSi₃O₈), 9 wt % to 19 wt % dolomite (CaMg(Co₃)₂) and 3 wt % to 7 wt % salt (NaCl).

In other embodiments, the low melting temperature material my be formed from a CMAS powder (having a melting temperature of less than 1500° C.) where the CMAS powder is selected from one of the following compositions:
Composition 1:60.0 mol % to 70.0 mol % SiO₂, 15.0 mol % to 31.0 mol % CaO, 6.0 mol % to 10.0 mol % MgO, 2.0 mol % to 5.0 mol % Al₂O₃, 0.5 mol % to 5.0 mol % Na₂O, and 0.1 mol % to 1.0 mol % K₂O;
Composition 2:50.0 mol % to 65.0 mol % SiO₂, 25.0 mol % to 40.0 mol % CaO, 1.0 mol % to 6.0 mol % MgO, 1.0 mol % to 3.5 mol % Al₂O₃, 3.0 mol % to 5.0 mol % Na₂O, and 0.01 mol % to 0.5 mol % K₂O; and
Composition 3:25.0 mol % to 55.0 mol % SiO₂, 35.0 mol % to 60.0 mol % CaO, 0.5 mol % to 5.0 mol % MgO, 0.5 mol % to 3.0 mol % Al₂O₃, 1.0 mol % to 5.0 mol % Na₂O, and 0.0 mol % to 0.2 mol % K₂O.

In some embodiments, the high melting temperature matrix material is composed of rare earth silicates (including rare earth elements Y, La, Ce, Pr, Nd, Pm, Sm, Eu, Gd, Tb, Dy, Ho, Er, Tm, Yb, Lu), rare earth oxides (including rare earth elements Y, La, Ce, Pr, Nd, Pm, Sm, Eu, Gd, Tb, Dy, Ho, Er, Tm, Yb, Lu), mullite (3Al₂O₃—2SiO₂), alkaline silicate (BaO—SrO—Al₂O₃—SiO₂), HfO₂, HfSiO₄, HfTiO₄, ZrTiO₄, ZrSiO₄, rare earth oxides stabilized zirconia, rare earth oxides stabilized hafnia, HfB₂, HfC, ZrB₂, ZrC, SiC, and combinations thereof. In some embodiment, the materials of the high melting temperature matrix may be selected such that the matrix has a melting temperature that is at least 350° C. higher than the melting temperature of the low melting temperature material. In some embodiments, the matrix that is formed from the high melting temperature matrix material may have a melting temperature that is in a range of from 1800° C. to 3900° C., particularly a melting temperature that is in a range of from 2200° C. to 3400° C., more particularly a melting temperature that is in a range of from 2500° C. to 3000° C.

In some embodiments, the EBC of the present disclosure may be formed from a thermal spray material feedstock that includes: (i) a first powder including a low melting temperature material having a melting temperature of less than 1500° C., and (ii) a second powder including a high melting temperature matrix material.

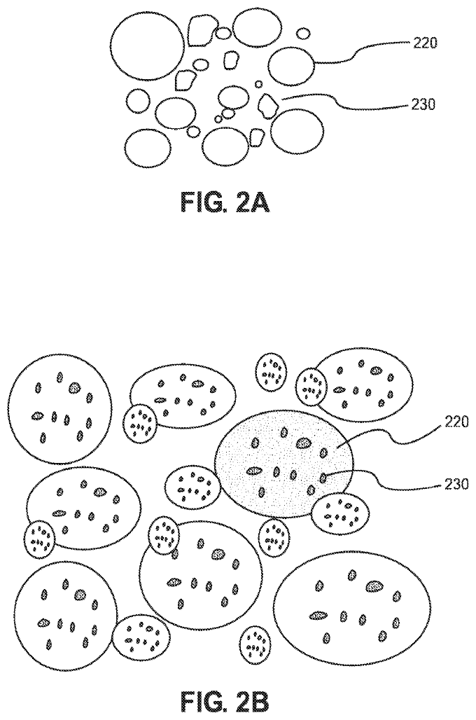

FIG. 2A illustrates a schematic drawing of an exemplary embodiment of a thermal spray material feedstock where the thermal spray material feedstock comprises a blended powder that includes a high melting temperature matrix materials powder 220 and a low melting temperature materials powder 230.

In some embodiments, the particle size distribution (in terms of the particle diameter) of the high melting temperature matrix materials powder may range from 11 μm to 200 μm. In a preferred embodiment, the particle size distribution of the high melting temperature matrix materials powder may range from 11 μm to 150 μm. In a more preferred embodiment, the particle size distribution of the high melting temperature matrix materials powder may range from 11 μm to 125 μm.

In some embodiments, the high melting temperature matrix materials powder may have an average size (diameter) that is in a range of from 25 μm to 125 μm, preferably in a range of from 25 μm to 90 μm.

In some embodiments, the particle size distribution (in terms of the particle diameter) of the low melting temperature materials powder may range from 1 μm to 125 μm. In a preferred embodiment, the particle size distribution of the low melting temperature materials powder may range from 2.5 μm to 75 μm, such as from 5 μm to 62 μm. In a more preferred embodiment, the particle size distribution of the low melting temperature materials powder may range from 5 μm to 55 μm.

In some embodiments, the low melting temperature materials powder may have an average size (diameter) that is in a range of from 5 μm to 40 μm, preferably in a range of from 5 μm to 25 μm.

In some embodiments, the low melting temperature materials powder has an average size (diameter) that is less than that of the high melting temperature matrix materials powder (such as, for example, an average size that is at least 30% less (preferably at least 50% less) than that of the high melting temperature matrix materials powder).

In some embodiments, the EBC of the present disclosure may be formed from a thermal spray material feedstock that includes an agglomerated powder. FIG. 2B is a schematic drawing of an exemplary embodiment of a thermal spray material feedstock where the thermal spray material feedstock comprises an agglomerated powder particle that includes a high melting temperature matrix materials powder 220 and a low melting temperature materials powder 230.

In some embodiments, the particle size distribution of the agglomerated powder may range from 11 μm to 125 μm. In a preferred embodiment, the particle size distribution of the agglomerated powder may range from 11 μm to 90 μm. In a more preferred embodiment, the particle size distribution of the agglomerated powder may range from 11 μm to 62 μm.

In some embodiments, the high melting temperature matrix material powder and the low melting temperature material powder in the thermal spray material feedstock is manufactured by one or more of the following methodologies: blending, agglomerating, agglomerating and sintering, plasma densification, or fusing and crushing.

In embodiments, the Si-based bond coat and EBCs top coat on a Si-based ceramic matrix composite (CMC) may be deposited by one of the following methodologies (using conditions known to those skilled in the art): Air Plasma Spray (APS), High Velocity Oxy-Fuel (HVOF), a combustion spray, a vacuum plasma spray, or a suspension thermal spray. For example, in embodiments in which the Si-based bond coat and EBCs top coat are deposited on a Si-based ceramic matrix composite (CMC) via APS, the conditions shown in Table 5 (below) may be used.

TABLE 5

| | Si Bond Coat | Top Coat |
|---|---|---|
| Current A | 450 | 500 |
| Voltage V | 96.6 | 97 |
| Power kW | 44.3 | 50 |
| Ar nlpm | 75 | 70 |
| H₂ n1pm | 5 | 5 |
| Powder feeding rate g/min | 10-50 | 10-50 |
| Coating thickness (μm) | 150 | 200 |

In some embodiments, the low melting temperature material(s) may be specifically selected and provided in the EBC in an amount effective such that at or below a predetermined heat treatment temperature at least some of the selected low melting temperature material(s) is able to melt, diffuse, and at least partially fill microstructural defects, such as micro-cracks and splat boundaries, that occur during the EBCs deposition. In preferred embodiments, the low melting temperature material(s) may be specifically selected and provided in the EBC in an amount effective such that at or below a predetermined heat treatment temperature at least some of the selected low melting temperature material(s) is able to melt, diffuse, and substantially fill microstructural defects (e.g., fill at least 90% or at least 95% of the microstructural defect volume that is initially present), such as micro-cracks and splat boundaries, that occur during the EBCs deposition. Due to reduced microstructural defects, some embodiments of the present disclosure include EBCs containing low melting temperature materials that provide an enhanced oxidant diffusion barrier and a more than two-times (such as more than five times or more than 10 times (e.g., a magnitude that is in the range of from five to 20 times)) slower TGO growth rate as compared to coatings without low melting temperature materials.

In some embodiments, the low temperature material is present in the EBC top coat layer in an amount that is in the range of from 0.1 wt % to 40 wt % based on the total weight of the EBC top coat layer. In another embodiment, the low temperature material is present in the EBC top coat layer in an amount that is in the range of from of 0.5 wt % to 10 wt % based on the total weight of the EBC top coat layer. In yet another embodiment, the low temperature material is present in the EBC top coat layer in an amount that is in the range of from 1.0 wt % to 5.0 wt % based on the total weight of the EBC top coat layer.

In some embodiments, the EBCs of the present disclosure may be prepared by methods that include a coating post heat treatment process. In such embodiments, the heat treatment temperature may be at a temperature that is effective (i.e., high enough) to allow the low melting temperature material to melt and diffuse within the matrix structure of the EBC (e.g., the matrix structure formed by the high melting temperature matrix material), such as at a temperature that is equal to or at least 50° C. higher than the melting temperature of the low melting temperature material, or a temperature that is in the range of from 50° C. to 150° C. higher than the melting temperature of the low melting temperature material. In some embodiments, the heat treatment temperature may be equal to or higher than a temperature sufficient to ensure that 100% of the low melting temperature material is fully melted to form a liquid phase. For example, the heat treatment temperature may be equal to or at least 100° C. higher than the melting temperature of the low melting temperature material to ensure that the low melting temperature material is fully melted to form a liquid phase in the environmental barrier coating matrix (EBC matrix, which is formed by the high melting temperature matrix material) and fill the micro-cracks in the EBC.

The present invention is further illustrated by the following non-limiting examples where all parts, percentages, proportions, and ratios are by weight, all temperatures are in ° C., and all pressures are atmospheric unless otherwise indicated:

### EXAMPLES

Several specific EBCs were prepared as example embodiments of the innovation disclosed herein. These examples are included herein for the purposes of illustration.

In the Examples, Metco 4810 Si powder was used for bond coat deposition and M6157 Yb₂Si₂O₇ powder was used for baseline top coat deposition. The Yb₂Si₂O₇/Si baseline EBCs as well as the Yb₂Si₂O₇ containing low melting temperature phase/Si were deposited onto SiC substrates using the SinplexPro plasma torch with a 9 mm nozzle.

All of the as-sprayed coatings were further annealed at 1300° C. for 10 hours in air atmosphere. The heat treated EBCs were evaluated isothermally in a steam furnace at 1316° C. to investigate the growth behavior of thermally growth oxides (TGO). Water was injected to the furnace using a peristaltic pump along with air. The amount of water and air was controlled so as to create an environment with about 90 vol % H₂O (g) with about 10 vol % air where a 4 cm/s gas velocity was present in the hot zone of the furnace chamber. The thermally grown oxides (TGO) thickness for various exposure times was measured using scanning electron microscopy (SEM).

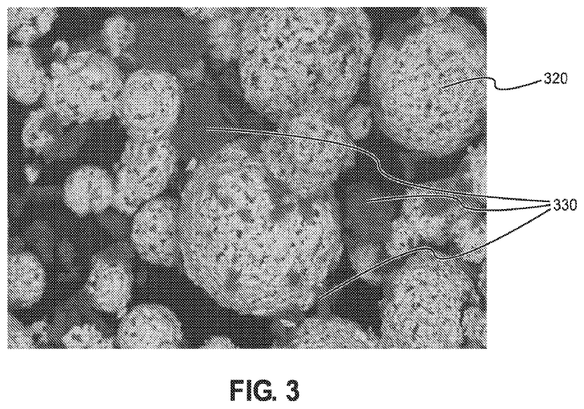

Example 1: FIG. 3 illustrates a SEM image of a high melting temperature matrix powder 320 that is composed of Metco 6157 Yb₂Si₂O₇ having a high melting temperature of about 1850° C. and a low melting temperature powder 330 that is composed of sodium calcium magnesium aluminosilicate powder having a melting temperature of about 1140° C. In FIG. 3, the bright phase is Yb₂Si₂O₇ and the dark phase is the sodium calcium magnesium aluminosilicate powder.

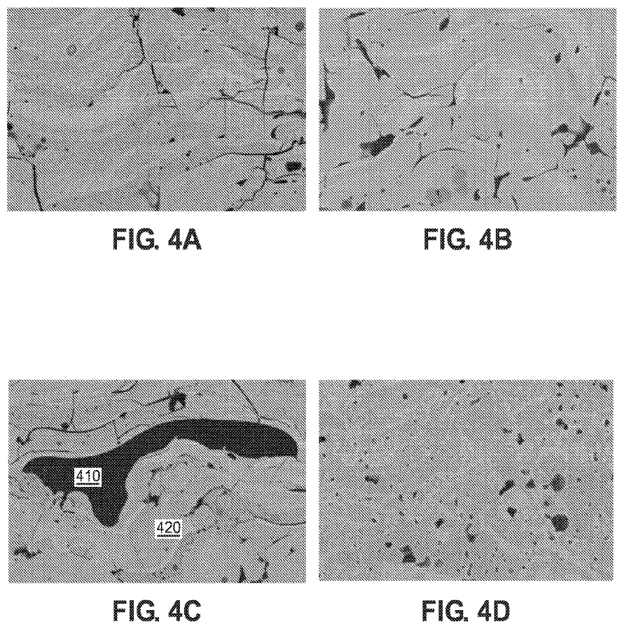

Comparative Example 1A: FIG. 4A illustrates a SEM image of an as-sprayed APS Yb₂Si₂O₇ coating. In FIG. 4A, the SEM image shows micro-cracks and splat boundaries (the splat boundary being at the boundary between two splats, for example, where remelting and/or recrystallization of the material near the splat surface (during the thermal spray production process) resulted in an interface (between the splats) with a different morphology from the material inside the splats) in the as-sprayed APS Yb₂Si₂O₇ coating.

Comparative Example 1B: FIG. 4B illustrates a SEM image of a heat-treated APS Yb₂Si₂O₇ coating. In FIG. 4B, the SEM image shows micro-cracks and splat boundaries in a heat-treated APS Yb₂Si₂O₇ coating at 1300° C. for 10 hours.

Example 1A: FIG. 4C illustrates a SEM image of as-sprayed APS Yb₂Si₂O₇-sodium calcium magnesium aluminosilicate coating. In FIG. 4C, the SEM image shows micro-cracks and splat boundaries in the as-sprayed APS Yb₂Si₂O₇-sodium calcium magnesium aluminosilicate coating. FIG. 4C also shows the sodium calcium magnesium aluminosilicate phase 410 distribution in the Yb₂Si₂O₇ matrix 420.

Example 1B: FIG. 4D illustrates a SEM image of a heat-treated APS Yb₂Si₂O₇-sodium calcium magnesium aluminosilicate coating. In FIG. 4D, the SEM image shows the disappearance of micro-cracks and splats boundaries, as well as the disappearance of the low melting sodium calcium magnesium aluminosilicate phase in the heat-treated APS Yb₂Si₂O₇-sodium calcium magnesium aluminosilicate coating at 1300° C. for 10 hours.

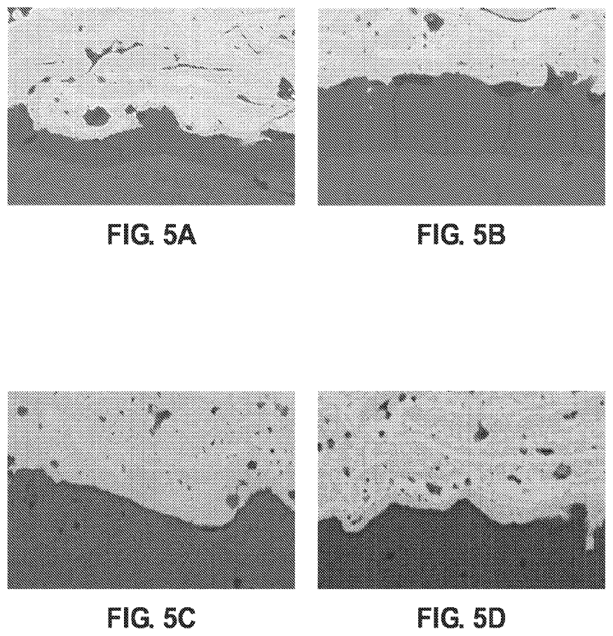

Comparative Example 1C: FIG. 5A illustrates a SEM image of a Yb₂Si₂O₇ coating evaluated at 1316° C. in 90 vol % H₂O-10 vol % air after 170 hours exposure time. In FIG. 5A, the SEM image shows a TGO thickness of about 6 μm in the Yb₂Si₂O₇ coating.

Comparative Example 1D: FIG. 5B illustrates a SEM image of a Yb₂Si₂O₇ coating evaluated at 1316° C. in 90 vol % H₂O-10 vol % air after 510 hours exposure time. In FIG. 5B, the SEM image shows a TGO thickness of about 13.5 μm in the Yb₂Si₂O₇ coating.

Example 1C: FIG. 5C illustrates a SEM image of a Yb₂Si₂O₇-sodium calcium magnesium aluminosilicate coating evaluated at 1316° C. in 90 vol % H₂O-10 vol % air after 170 hours exposure time. In FIG. 5C, the SEM image shows a TGO thickness of about 0.67 μm in the Yb₂Si₂O₇-sodium calcium magnesium aluminosilicate coating.

Example 1D: FIG. 5D illustrates a SEM image of a Yb₂Si₂O₇-sodium calcium magnesium aluminosilicate coating evaluated at 1316° C. in 90 vol % H₂O-10 vol % air after 510 hours exposure time. In FIG. 5D, the SEM image shows a TGO thickness of about 1.1 μm in the Yb₂Si₂O₇-sodium calcium magnesium aluminosilicate coating.

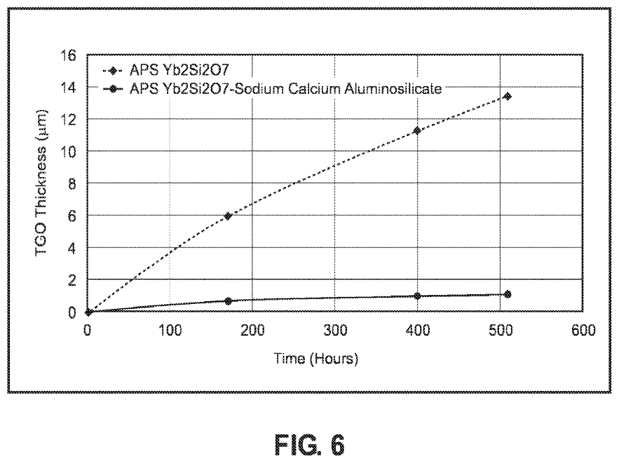

FIG. 6 is a graph showing the TGO thickness as a function of exposure for a Yb₂Si₂O₇ coating and an APS Yb₂Si₂O₇-sodium calcium magnesium aluminosilicate coating at 1316° C. in 90 vol % H₂O-10 vol % air. In FIG. 6, the TGO growth rate in EBCs containing low melting sodium calcium magnesium aluminosilicate is about 10× slower than that of the Yb₂Si₂O₇ coating.

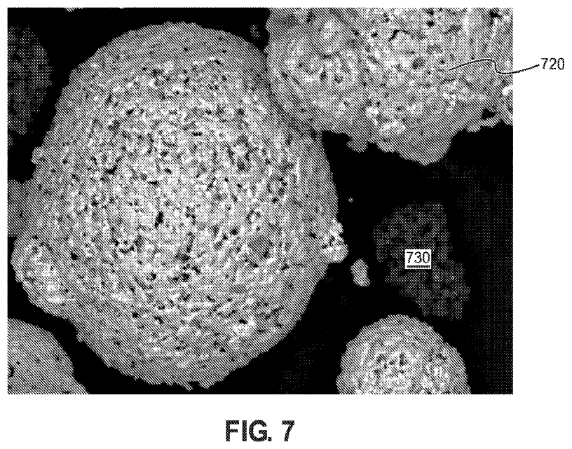

Example 2: FIG. 7 illustrates a SEM image of a high melting temperature matrix powder 720 that is composed of Metco 6157 Yb₂Si₂O₇ having a high melting temperature of about 1850° C. and a low melting temperature powder 730 that is composed of Li₂O having a melting temperature of about 1438° C. In FIG. 7, the bright phase is Yb₂Si₂O₇ and the dark phase is the Li₂O powder.

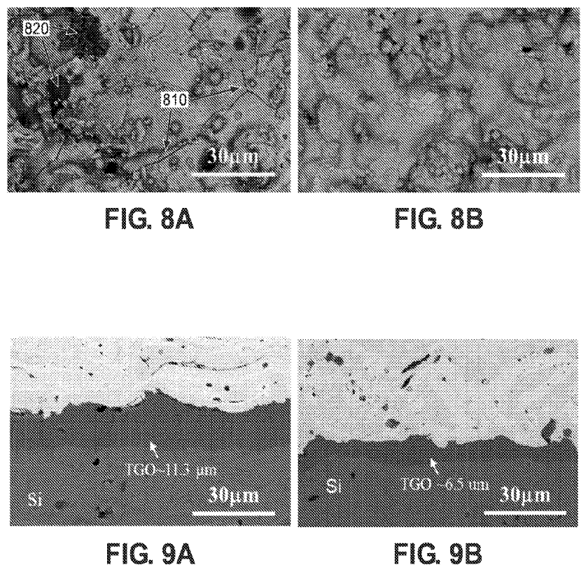

Example 2A: FIG. 8A illustrates a SEM image of as-sprayed APS Yb₂Si₂O₇-0.4 wt % Li₂O coating. In FIG. 8A, the SEM image shows micro-cracks 810. FIG. 8A also shows the Li₂O 820 distribution in the Yb₂Si₂O₇ matrix.

Example 2B: FIG. 8B illustrates a SEM image of a heat-treated APS Yb₂Si₂O₇-0.4 wt % Li₂O coating. In FIG. 8B, the SEM image shows the disappearance of micro-cracks and that the coating was densified in the heat-treated APS Yb₂Si₂O₇-0.4 wt % Li₂O coating at 1300° C. for 10 hours.

Comparative Example 2A: FIG. 9A illustrates a SEM image of a Yb₂Si₂O₇ coating evaluated at 1316° C. in 90 vol % H₂O-10 vol % air after 410 hours exposure time. In FIG. 9A, the SEM image shows a TGO thickness of about 11.3 μm in the Yb₂Si₂O₇ coating.

Example 2C: FIG. 9B illustrates a SEM image of a Yb₂Si₂O₇-0.4 wt % Li₂O coating evaluated at 1316° C. in 90 vol % H₂O-10 vol % air after 410 hours exposure time. In FIG. 9B, the SEM image shows a TGO thickness of about 6.5 μm in the Yb₂Si₂O₇-0.4 wt % Li₂O coating.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A thermal spray material feedstock, comprising:
(a) a first powder comprising at least one low melting temperature material having a melting temperature of less than 1500° C.; and
(b) a second powder comprising at least one environmental barrier coating matrix material.

2. The thermal spray material feedstock according to claim 1, wherein the at least one low melting temperature material is a single oxide compound, a binary oxide, a ternary oxide, or multiple oxides.

3. The thermal spray material feedstock as claimed in claim 1, wherein the low melting temperature material is the multiple oxides comprising at least four oxides having a melting temperature of less than 1300° C.

4. The thermal spray material feedstock as claimed in claim 1, wherein the at least one environmental barrier coating matrix material comprises at least one high melting temperature matrix material selected from the group consisting of a rare earth silicate, a rare earth oxide, mullite, alkaline silicate, HfO₂, HfSiO₄, HfTiO₄, ZrTiO₄, ZrSiO₄, a rare earth oxide stabilized zirconia, a rare earth oxide stabilized hafnia, HfB₂, HfC, ZrB₂, ZrC, and SiC.

5. The thermal spray material feedstock as claimed in claim 1, wherein the first powder and the second powder are blended, agglomerated, agglomerated and sintered, plasma densified, or fused and crushed.

6. The thermal spray material feedstock as claimed in claim 1, wherein the at least one low melting temperature material comprises CaO, MgO, Al₂O₃, SiO₂, Na₂O, K₂O and Fe₂O₃.

7. The thermal spray material feedstock according to claim 1, wherein the at least one low melting temperature material is Li₂O.

8. An environmental barrier coating (EBC), comprising:
(I) an EBC top coat comprising:
(i) an EBC matrix comprising at least one selected from the group consisting of a rare earth silicate, a rare earth oxide, mullite, alkaline silicate, HfO₂, HfSiO₄, HfTiO₄, ZrTiO₄, ZrSiO₄, a rare earth oxide stabilized zirconia, a rare earth oxide stabilized hafnia, HfB₂, HfC, ZrB₂, ZrC, and SiC; and
(ii) at least one low melting temperature material having a melting temperature of less than 1500° C. that is embedded in the EBC matrix; and
(II) a Si-based bond coat.

9. The EBC according to claim 8, wherein the at least one low melting temperature material comprises CaO, MgO, Al₂O₃, SiO₂, Na₂O, K₂O and Fe₂O₃.

10. The EBC according to claim 8, wherein the at least one low melting temperature material is Li₂O.

11. The EBC according to claim 8, wherein the EBC matrix comprises at least one rare earth silicate comprising at least one rare earth element selected from the group consisting of Y, La, Ce, Pr, Nd, Pm, Sm, Eu, Gd, Tb, Dy, Ho, Er, Tm, Yb, and Lu.

12. The EBC according to claim 8, wherein the EBC matrix comprises at least one rare earth oxide comprising at least one rare earth element selected from the group consisting of Y, La, Ce, Pr, Nd, Pm, Sm, Eu, Gd, Tb, Dy, Ho, Er, Tm, Yb, and Lu.

13. The EBC according to claim 8, wherein the at least one low temperature material concentration in the EBC matrix is in a range of 0.1 wt % to 40 wt % based on the total weight of the EBC top coat.

14. The EBC according to claim 8, wherein the at least one low temperature material concentration in the EBC matrix is in a range of 0.4 wt % to 10 wt % based on the total weight of the EBC top coat.

15. The EBC according to claim 8, wherein the at least one low temperature material concentration in the EBC matrix is in range of 0.4 wt % to 5.0 wt % based on the total weight of the EBC top coat.

16. A method of applying an EBC on a Si-based CMC, comprising:
depositing the EBC of claim 8 on the Si-based CMC.

17. The method according to claim 16, wherein the depositing is performed by Air Plasma Spray (APS), High Velocity Oxy-Fuel (HVOF), a combustion spray, a vacuum plasma spray, or a suspension thermal spray.

18. An EBC top coat comprising:
(i) an EBC matrix comprising at least one selected from the group consisting of a rare earth silicate, a rare earth oxide, mullite, alkaline silicate, HfO₂, HfSiO₄, HfTiO₄, ZrTiO₄, ZrSiO₄, a rare earth oxide stabilized zirconia, a rare earth oxide stabilized hafnia, HfB₂, HfC, ZrB₂, ZrC, and SiC; and
(ii) at least one low melting temperature material having a melting temperature of less than 1500° C. that is embedded in the EBC matrix.
